(19) United States
(12) Patent Application Publication
(10) Pub. No.: US 2016/0197379 A1
(43) Pub. Date: Jul. 7, 2016

(54) SECONDARY BATTERY

(71) Applicant: SAMSUNG SDI CO., LTD., Yongin-si (KR)

(72) Inventor: Hyunki JUNG, Yongin-si (KR)

(21) Appl. No.: 14/957,638

(22) Filed: Dec. 3, 2015

(30) Foreign Application Priority Data
Jan. 7, 2015 (KR) 10-2015-0001948

(51) Int. Cl. H01M 10/0587

(52) U.S. Cl. CPC H01M 10/0587; H01M 2220/30

(57) ABSTRACT

A secondary battery including a wound electrode assembly including a negative electrode plate, a positive electrode plate, a separator interposed between the negative electrode plate and the positive electrode plate, a negative electrode tab connected to the negative electrode plate, and a positive electrode tab connected to the positive electrode plate; a case accommodating the wound electrode assembly; and a cap assembly sealing the case, the negative electrode tab being a a winding core portion of the wound electrode assembly.

### CROSS-REFERENCE TO RELATED APPLICATION

Korean Patent Application No. 10-2015-0001948, filed on Jan. 07, 2015 in the Korean Intellectual Property Office, and entitled: “Secondary Battery,” is incorporated by reference herein in its entirety.

### BACKGROUND

1. Field

Provided is a secondary battery.

2. Description of the Related Art

Portable wireless devices, such as video cameras, mobile phones, and portable computers, may be made more lightweight and functional, and secondary batteries may be used as their driving power sources. Such secondary batteries may include, for example, nickel-cadmium batteries, nickel-hydrogen batteries, nickel-zinc batteries, and lithium ion secondary batteries.

### SUMMARY

Embodiments may be realized by providing a secondary battery, including a wound electrode assembly including a negative electrode plate, a positive electrode plate, a separator interposed between the negative electrode plate and the positive electrode plate, a negative electrode tab connected to the negative electrode plate, and a positive electrode tab connected to the positive electrode plate; a case accommodating the wound electrode assembly; and a cap assembly sealing the case, the negative electrode tab being at a winding core portion of the wound electrode assembly.

The negative electrode plate may include a negative electrode current collector, a negative electrode active material coated on the negative electrode current collector, and a negative electrode uncoated portion at a winding edge of the negative electrode current collector, and the negative electrode tab may be connected to the negative electrode uncoated portion.

The negative electrode uncoated portion may be interior to the positive electrode tab in the wound electrode assembly, and the negative electrode tab may be wound.

A part of the negative electrode plate between the negative electrode tab and the negative electrode active material may be wound around the winding core portion at least one time interior to the positive electrode plate in the wound electrode assembly.

The negative electrode active material may include one of graphite, a graphite-metal based composite, a silicon based composite, and a metal based active material, and the metal based active material may include one or more of silicon or tin.

The separator may be wound around the winding core portion interior to the negative electrode plate and the positive electrode plate in the wound electrode assembly.

The separator may be wound around the winding core two times or three times interior to the negative electrode plate and the positive electrode plate in the wound electrode assembly.

The positive electrode tab may be positioned between one-third and two-thirds of a distance from the winding core portion of the wound electrode assembly to an outer circumference of the wound electrode assembly in a radial direction from the winding core portion of the wound electrode assembly to the outer circumference of the wound electrode assembly.

The winding core portion of the wound electrode assembly may include a center portion of the wound electrode assembly that does not include the negative electrode plate or the positive electrode plate.

The negative electrode tab may be on a circumferential edge of a winding core portion of the wound electrode assembly.

Embodiments may be realized by providing a secondary battery, including a wound electrode assembly a negative electrode plate, a positive electrode plate, a separator interposed between the negative electrode plate and the positive electrode plate, a negative electrode tab connected to the negative electrode plate, and a positive electrode tab connected to the positive electrode plate; a case accommodating the wound electrode assembly; and a cap assembly sealing the case, the negative electrode tab being on a winding core portion of the wound electrode assembly, and the negative electrode plate being interposed between the negative electrode tab and the positive electrode plate adjacent to the negative electrode tab.

The negative electrode plate may include a negative electrode current collector, a negative electrode active material coated on the negative electrode current collector, and a negative electrode uncoated portion at a winding edge of the negative electrode current collector, the negative electrode tab may be connected to the negative electrode uncoated portion, and the negative electrode uncoated portion may be interposed between the negative electrode tab and the positive electrode plate adjacent to the negative electrode tab.

The winding core portion of the wound electrode assembly may include a center portion of the wound electrode assembly that does not include the negative electrode plate or the positive electrode plate.

The negative electrode tab may be on a circumferential edge of a winding core portion of the wound electrode assembly.

### BRIEF DESCRIPTION OF THE DRAWINGS

Features will become apparent to those of skill in the art by describing in detail exemplary embodiments with reference to the attached drawings in which:

FIG. 1 illustrates an assembled perspective view of a secondary battery according to an embodiment;

FIG. 2 illustrates an exploded perspective view of the secondary battery shown in FIG. 1;

FIG. 3 illustrates a diagram of an assembling sequence and configuration of an electrode assembly according to an embodiment;

FIG. 4 illustrates a horizontally cross-sectional view of the secondary battery shown in FIG. 1;

FIG. 5 illustrates a vertically cross-sectional view of the secondary battery shown in FIG. 1;

FIG. 6 illustrates a graph of a change in the volumetric change of a negative electrode plate depending on charging/discharging cycles of the secondary battery shown in FIG. 1; and

FIG. 7 illustrates a graph of a volumetric expansion ratio of a negative electrode plate depending on the amount of a negative electrode active material.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

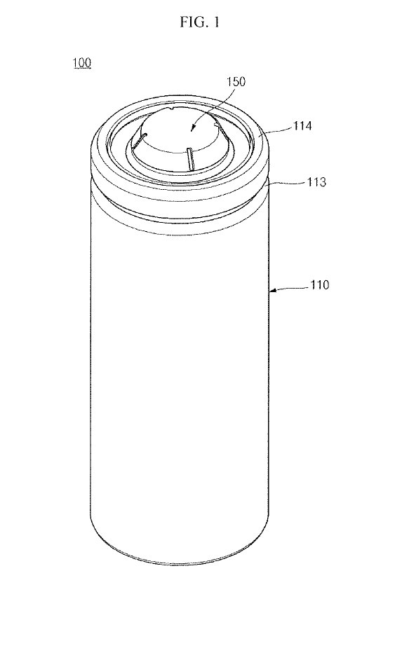

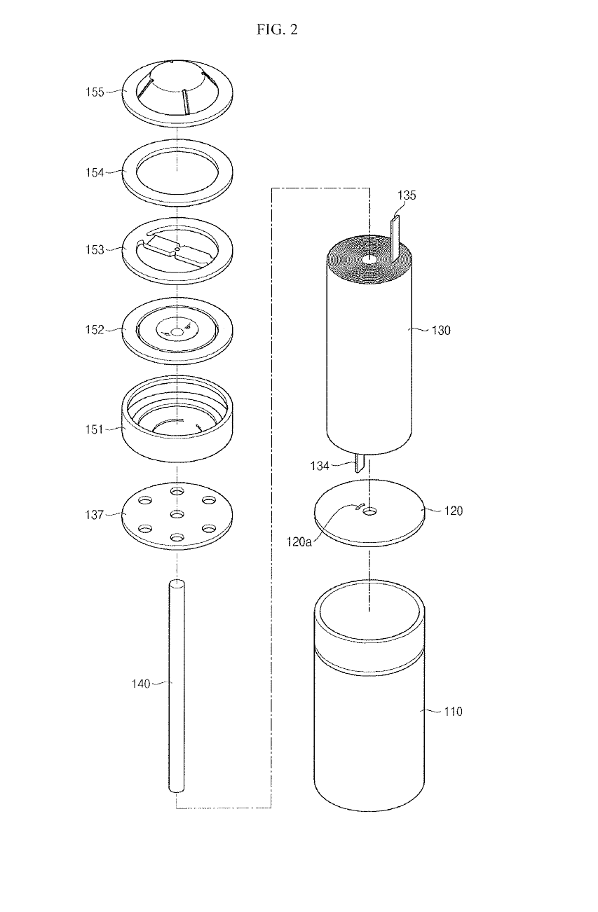

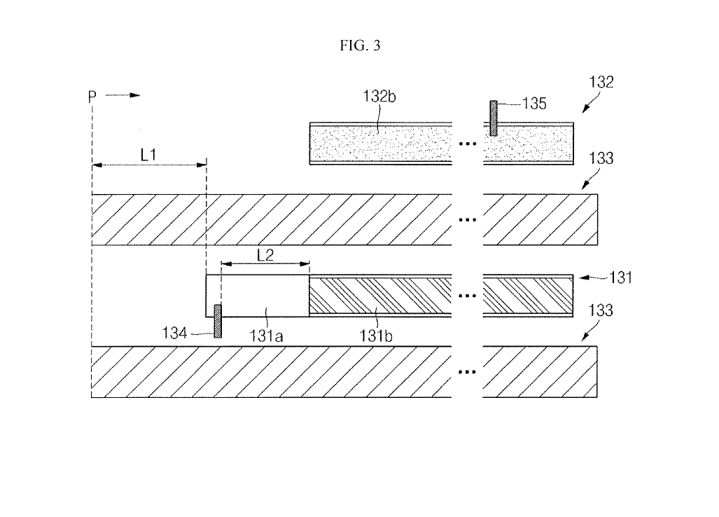

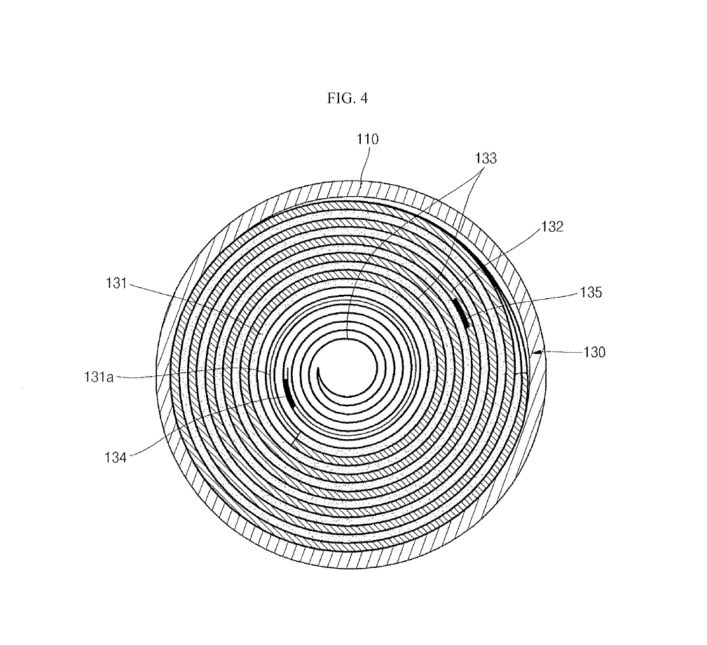

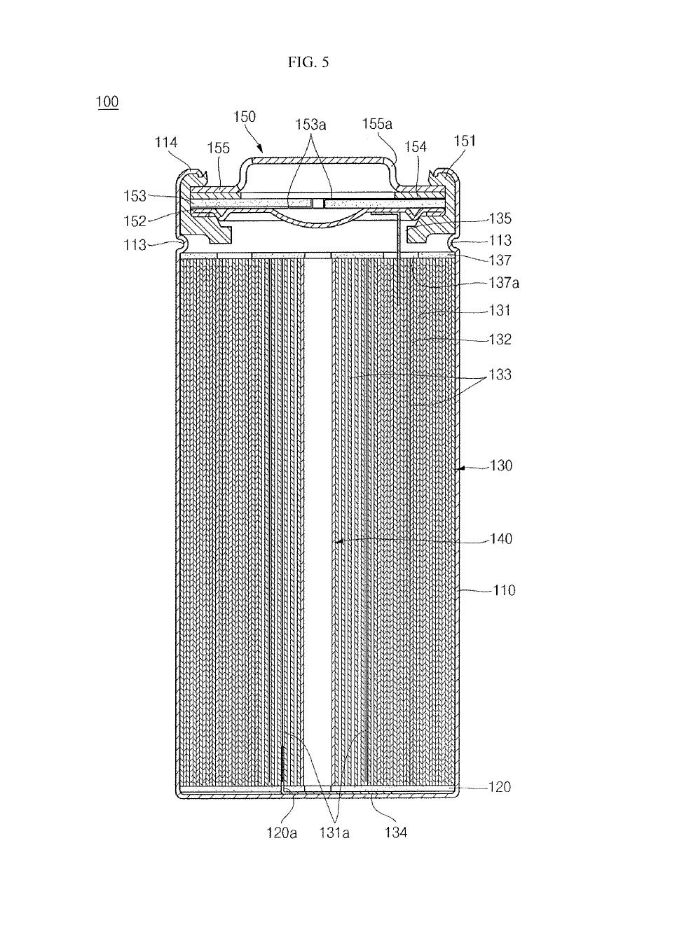

FIG. 1 illustrates an assembled perspective view of a secondary battery according to an embodiment, FIG. 2 illustrates an exploded perspective view of the secondary battery shown in FIG. 1, FIG. 3 illustrates a diagram of an assembling sequence and configuration of an electrode assembly according to an embodiment, FIG. 4 illustrates a horizontally cross-sectional view of the secondary battery shown in FIG. 1, and FIG. 5 illustrates a vertically cross-sectional view of the secondary battery shown in FIG. 1.

Referring to FIGS. 1 to 5, the secondary battery 100 according to an embodiment may include a case 110, an electrode assembly 130 and a cap assembly 150. The secondary battery 100 may further include a lower insulation plate 120 and a center pin 140.

The case 110 may have a cylindrical surface 111 having a predetermined diameter and a disk-shaped bottom surface 112 and may be shaped of a cylindrical can having a top opening. The electrode assembly 130 and the center pin 140 may be accommodated inside the case 110 through the top opening. The case 110 may be formed of, for example, steel, steel use stainless (SUS), aluminum or equivalents thereof. The negative electrode tab 134 of the electrode assembly 130 may be welded to the bottom surface 112 of the case 110, and the case 110 may function as a negative electrode. In an embodiment, the positive electrode tab 135 may be welded to the bottom surface 112 of the case 110, and the case 110 may function as a positive electrode.

The electrode assembly 130 may be accommodated in the case 110 and may be positioned on the lower insulation plate 120. The electrode assembly 130 may include a negative electrode plate 131, a positive electrode plate 132, a separator 133 interposed between the negative electrode plate 131 and the positive electrode plate 132, a negative electrode tab 134 connected to the negative electrode plate 131, and a positive electrode tab 135 connected to the positive electrode plate 132.

The negative electrode plate 131 may include a negative electrode active material portion 131b having a negative electrode active material coated on a negative electrode current collector, and a negative electrode uncoated portion 131a having the negative electrode active material portion 131b not coated on, e.g., at, a winding edge of the negative electrode current collector. The negative electrode current collector may include copper (Cu), the negative electrode active material portion 131b may include graphite, a graphite-metal based composite, a silicon based composite, or a metal based active material, and the metal based active material may include, for example, silicon or tin.

The positive electrode plate 132 may include a positive electrode active material portion 132b having a positive electrode active material coated on a positive electrode current collector. The positive electrode current collector may be formed of an aluminum (Al) foil, and the positive electrode active material portion 132b may include, for example, a transition metal oxide, such as LiCoO₂, LiNiO₂, LiMn₂O₄.

The separator 133 may prevent an electrical short circuit between the negative electrode plate 131 and the positive electrode plate 132, and may allow lithium ions to migrate between the respective electrode plates. The separator 133 may include, for example, polyethylene (PE) or polypropylene (PP).

The negative electrode tab 134 may be welded to the negative electrode uncoated portion 131a and may protrude and extend a predetermined length to a lower portion of the negative electrode plate 131. The negative electrode tab 134 may include, for example, nickel (Ni). A portion of the negative electrode tab 134 protruding and extending from the negative electrode plate 131 may pass through a first hole 120a formed in the lower insulation plate 120 and may be bent to then be welded to the bottom surface 112 of the case 110.

The positive electrode tab 135 may be welded to the positive electrode plate 132 and may protrude and extend from an upper portion of the positive electrode plate 132. The positive electrode tab 135 may include, for example, aluminum (Al).

Hereinafter, a winding method of the electrode assembly 130 and a positional relationship between the negative electrode tab 134 and the positive electrode tab 135 will be described in detail.

As shown in FIG. 3, the separator 133 may be positioned between the negative electrode plate 131 and the positive electrode plate 132. In this embodiment, the separator 133 may be positioned such that a leading edge of the separator 133 is placed at a winding start point P. The negative electrode plate 131 may be positioned such that the negative electrode uncoated portion 131 a corresponding to the leading edge of the negative electrode plate 131 is spaced a first length L1 apart from the winding start point P. The negative electrode tab 134 may be connected to the negative electrode uncoated portion 131a and may be connected to a position which is spaced a second length L2 apart from the negative electrode active material portion 131b. The positive electrode plate 132 may be positioned such that the leading edge of the positive electrode plate 132 is placed at a position which is spaced the second length L2 apart from the negative electrode tab 134 or a position at which the negative electrode active material portion 131b starts.

In such a disposed state, winding may start from the winding start point P, and the separator 133 may be wound the first length L1 earlier than the negative electrode plate 131 and the positive electrode plate 132, e.g., the first length L1 of the separator 133 may be interior to the negative electrode plate 131 and the positive electrode plate 132 in the wound electrode assembly 130, constituting a winding core portion of the electrode assembly 130, e.g., the winding core portion of the electrode assembly may include a center portion of the wound electrode assembly 130 that does not include the negative electrode plate 131 or the positive electrode plate 132. The first length L1 may be long enough to allowing winding the separator 133 two times or three times. The first length L1 may vary according to the diameter of a mandrel, and a numerical value of the first length L1 is not specifically defined.

As described above, after the separator 133 is first wound two times or three times, winding of the negative electrode plate 131 may start. The negative electrode plate 131 may be wound from the negative electrode uncoated portion 131a connected to the negative electrode tab 134, and the negative electrode tab 134 may be positioned at or on, e.g., on a circumferential edge of, the winding core portion of the electrode assembly 130. In the negative electrode uncoated portion 131a, a portion between the negative electrode tab 134 and the negative electrode active material portion 131b may be wound at least one time while passing through the negative electrode tab 134, e.g., the negative electrode tab may be wound.

The second length L2 may be long enough to allow winding the negative electrode uncoated portion 131a at least one time to pass through the negative electrode tab 134, e.g., the negative electrode tab may be wound. The second length L2 may vary according to the diameter of a mandrel, and a numerical value of the second length L2 is not specifically defined.

As described above, after the separator 133 and the negative electrode uncoated portion 131a are sequentially wound, winding of the positive electrode plate 132 and the negative electrode active material portion 131b may start. The positive electrode tab 135 may be connected to the positive electrode plate 132 such that it is positioned one-thirds to two-thirds of a distance from the winding core portion of the electrode assembly 130 to the outermost part of the electrode assembly 130, e.g., the positive electrode tab may be positioned between one-third and two-thirds of a distance from the winding core portion of the wound electrode assembly 130 to an outer circumference of the wound electrode assembly 130 in a radial direction from the winding core portion of the wound electrode assembly 130 to an outer circumference of the wound electrode assembly 130.

The electrode assembly 130 may be assembled in such a manner, as shown in FIG. 4, and the negative electrode tab 134 may be positioned at or on, e.g., on a circumferential edge of, the winding core portion of the electrode assembly 130. In such a case, the stress applied to a connection part between the negative electrode tab 134 and the negative electrode plate 131 may be reduced according to the volumetric expansion during charging or discharging of a cell, and it may be possible to minimize fatigue fracture of the negative electrode tab 134, compared to a comparative electrode assembly having the negative electrode tab positioned at its outermost part, e.g., an outer circumference of the comparative electrode assembly.

At least one or more layers of negative electrode uncoated portions 131a may be interposed between the negative electrode tab 134 and the positive electrode plate 132, and it may be possible to prevent the negative electrode tab 134 from making direct contact with the positive electrode plate 132 even if the separator 133 is melted, for example, due to an increase in the temperature of the negative electrode tab 134 in an event of an external short circuit.

The center pin 140 may be coupled to roughly the center of the electrode assembly 130 and may suppress deformation of the electrode assembly 130 during charging or discharging of the cell.

The center pin 140 may have a roughly hollow cylindrical shape. The center pin 140 may be made of a metal, such as steel use stainless (SUS), or an insulating material, such as polybutylene terephthalate (PBT). An upper insulation plate 137 having a plurality of second holes 137a may be interposed between the electrode assembly 130 and a top portion of the center pin 140. The positive electrode tab 135 may pass through the upper insulation plate 137 and an electrolyte solution may be injected through the second holes 137a. As described above, the upper insulation plate 137 may prevent the electrode assembly 130 and the cap assembly 150 from contacting each other.

The cap assembly 150 may be assembled such that an insulating gasket 151 is coupled to an upper region of the case 110 (that is, the electrode assembly 130 and the top portion of the center pin 140) in a substantially ring shape and a conductive safety vent 152 is coupled to the insulating gasket 151. In the present embodiment, the positive electrode tab 135 may be connected to the safety vent 152. In an embodiment, the negative electrode tab 134 may be connected to the safety vent 152. When the internal pressure of the cylindrical can 130 increases, the safety vent 152 may be deformed or fractured, and a circuit board 153 to be described later may be damaged or the internal gases may be evacuated to the outside.

The circuit board 153, which may be fractured or broken when the safety vent 152 deforms to interrupt the flow of current, may further be positioned on top of the safety vent 152, and a positive temperature coefficient (PTC) device 154, which interrupts the flow of current, may be positioned on the circuit board 153. A positive voltage (or a negative voltage) may be provided to an upper portion of the PTC device 154, and a conductive positive electrode cap 155 (or a negative electrode cap) having a plurality of through-holes 155a may further be provided to facilitate gas evacuation. The safety vent 152, the circuit board 153, the PTC device 154 and the positive electrode cap 155 may all be mounted within the insulating gasket 151, and it may be possible to prevent these components from being short-circuited directly from the cylindrical can 110. A wire pattern 153a may be formed on a surface of the circuit board 153, the circuit board 153 may be fractured or broken, and the wire pattern 153a may naturally be cut off.

A beading part 113, which may be inwardly recessed about the cap assembly 150, may be positioned on a lower portion of the cap assembly 150 and may prevent the cap assembly 150 from deviating to the outside, and a crimping part 114, which may be bent towards an interior of the battery, may be formed on an upper portion of the cap assembly 150. The beading part 113 and the crimping part 114 may firmly fix and support the cap assembly on the cylindrical can 110 and may prevent an electrolyte from leaking out.

The cylindrical can 110 may have the electrolyte injected therein to enable movement of lithium ions, the ions being created by an electrochemical reaction carried out between the negative electrode and positive electrode plates 131 and 132 within the battery during charging or discharging. The electrolyte may be a non-aqueous organic electrolyte, such as a mixture of lithium salt and high-purity organic solvent. The electrolyte may instead be, for example, a polymer using a high-molecular electrolyte.

According to an embodiment, the stress applied to a connection part between a negative electrode tab and a negative electrode plate may be reduced according to volumetric expansion during charging or discharging of a cell, and it may be possible to minimize fatigue fracture of the negative electrode tab, compared to a comparative electrode assembly having a negative electrode tab positioned at its outermost part.

A negative electrode uncoated portion may be positioned between the negative electrode tab and a positive electrode plate, and it may be possible to prevent the negative electrode tab from making direct contact with the positive electrode plate even if a separator is melted, for example, due to an increase in the temperature of the negative electrode tab in an event of an external short circuit of a secondary battery.

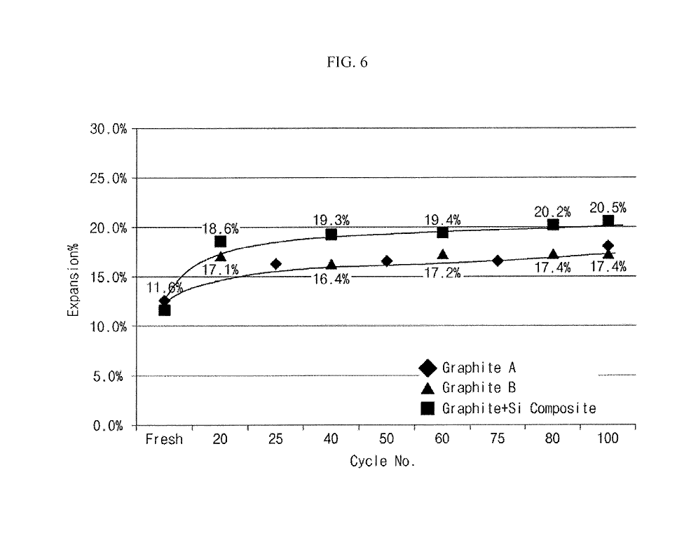

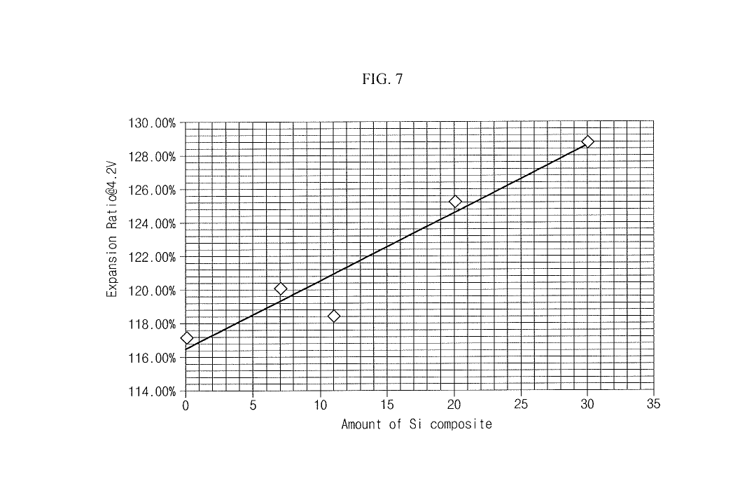

FIG. 6 illustrates a graph of a change in the volumetric change of a negative electrode plate depending on charging/discharging cycles of the secondary battery shown in FIG. 1, and FIG. 7 illustrates a graph of a volumetric expansion ratio of a negative electrode plate depending on the amount of a negative electrode active material.

As shown in FIGS. 6 and 7, when an expansion ratio of a negative electrode plate depending on the kind and amount of a negative electrode active material is high (that is, 1.45 g/cc or greater in composite density of the negative electrode plate), the electrode assembly may be effectively configured according to an embodiment.

By way of summation and review, lithium ion secondary batteries may be rechargeable, miniaturized, and have a maximized capacity. Lithium ion secondary batteries may have, for example, a high operating voltage and a high energy density per unit weight, and may be used in high-tech electronic devices.

As a battery having a high energy density may be designed to achieve high-capacity high-output performance, a negative electrode plate may be repetitively expanded and contracted. For example, in a case of a cylindrical secondary battery, a negative electrode tab may be positioned at an outermost part of an electrode assembly and stress may cumulatively increase, for example, due to repetitive expansion and contraction of the negative electrode plate, and a fatigue fracture of, e.g., in, the negative electrode tab may occur.

As described above, according to an embodiment, provided is a secondary battery, which may prevent a fatigue fracture from occurring in an electrode tab, for example, due to a volumetric expansion of an electrode assembly, and may prevent an internal short circuit from occurring in the electrode tab, for example, due to heat generated from the electrode tab.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a wound electrode assembly including a negative electrode plate, a positive electrode plate, a separator interposed between the negative electrode plate and the positive electrode plate, a negative electrode tab connected to the negative electrode plate, and a positive electrode tab connected to the positive electrode plate;
a case accommodating the wound electrode assembly; and
a cap assembly sealing the case,
the negative electrode tab being at a winding core portion of the wound electrode assembly.

2. The secondary battery as claimed in claim 1, wherein:
the negative electrode plate includes:
a negative electrode current collector,
a negative electrode active material coated on the negative electrode current collector, and
a negative electrode uncoated portion at a winding edge of the negative electrode current collector, and
the negative electrode tab is connected to the negative electrode uncoated portion.

3. The secondary battery as claimed in claim 2, wherein:
the negative electrode uncoated portion is interior to the positive electrode tab in the wound electrode assembly, and
the negative electrode tab is wound.

4. The secondary battery as claimed in claim 2, wherein a part of the negative electrode plate between the negative electrode tab and the negative electrode active material is wound around the winding core portion at least one time interior to the positive electrode plate in the wound electrode assembly.

5. The secondary battery as claimed in claim 2, wherein:
the negative electrode active material includes one of graphite, a graphite-metal based composite, a silicon based composite, and a metal based active material, and
the metal based active material includes one or more of silicon or tin.

6. The secondary battery as claimed in claim 1, wherein the separator is wound around the winding core portion interior to the negative electrode plate and the positive electrode plate in the wound electrode assembly.

7. The secondary battery as claimed in claim 6, wherein the separator is wound around the winding core two times or three times interior to the negative electrode plate and the positive electrode plate in the wound electrode assembly.

8. The secondary battery as claimed in claim 1, wherein the positive electrode tab is positioned between one-third and two-thirds of a distance from the winding core portion of the wound electrode assembly to an outer circumference of the wound electrode assembly in a radial direction from the winding core portion of the wound electrode assembly to the outer circumference of the wound electrode assembly.

9. The secondary battery as claimed in claim 1, wherein the winding core portion of the wound electrode assembly includes a center portion of the wound electrode assembly that does not include the negative electrode plate or the positive electrode plate.

10. The secondary battery as claimed in claim 1, wherein the negative electrode tab is on a circumferential edge of a winding core portion of the wound electrode assembly.

11. A secondary battery, comprising:
a wound electrode assembly a negative electrode plate, a positive electrode plate, a separator interposed between the negative electrode plate and the positive electrode plate, a negative electrode tab connected to the negative electrode plate, and a positive electrode tab connected to the positive electrode plate;
a case accommodating the wound electrode assembly; and
a cap assembly sealing the case,
the negative electrode tab being on a winding core portion of the wound electrode assembly, and the negative electrode plate being interposed between the negative electrode tab and the positive electrode plate adjacent to the negative electrode tab.

12. The secondary battery as claimed in claim 11, wherein the negative electrode plate includes a negative electrode current collector, a negative electrode active material coated on the negative electrode current collector, and a negative electrode uncoated portion at a winding edge of the negative electrode current collector, the negative electrode tab is connected to the negative electrode uncoated portion, and the negative electrode uncoated portion is interposed between the negative electrode tab and the positive electrode plate adjacent to the negative electrode tab.

13. The secondary battery as claimed in claim 11, wherein the winding core portion of the wound electrode assembly includes a center portion of the wound electrode assembly that does not include the negative electrode plate or the positive electrode plate.

14. The secondary battery as claimed in claim 11, wherein the negative electrode tab is on a circumferential edge of a winding core portion of the wound electrode assembly.
